(19) United States
(12) Patent Application Publication
(10) Pub. No.: US 2025/0111196 A1
(43) Pub. Date: Apr. 3, 2025

(54) SYSTEM AND METHOD FOR TIERED DEPLOYMENT OF ARTIFICIAL INTELLIGENCE MODELS

(71) Applicant: Graphium Health, Draper, UT (US)

(72) Inventors: Daniel Dura, Draper, UT (US); Siddharth Bhawsar, Logan, UT (US); Matthew Oldham, Dahlonega Hwy, GA (US); Jeff Zavaleta, Fort Worth, TX (US)

(21) Appl. No.: 18/883,116

(22) Filed: Sep. 12, 2024

Related U.S. Application Data
(60) Provisional application No. 63/586,516, filed on Sep. 29, 2023.

(51) Int. Cl. G06N 3/045

(52) U.S. Cl. CPC G06N 3/045

(57) ABSTRACT

Systems, methods, and computer-readable storage media for tiered deployment of multiple Artificial Intelligence (AI) models. The system receives first data associated with a human undergoing an experience, and executes a first artificial intelligence model using that data, with the result being a first satisfaction prediction for the human regarding the experience. At a later time, the system receives second data associated with the human undergoing the experience, and executes a second artificial intelligence model using at least a portion of the first data and the second data, where the second artificial intelligence model has a higher prediction accuracy than the first artificial intelligence model.

### CROSS REFERENCE

This application claims priority to U.S. provisional patent application No. 63/586,516, filed Sep. 29, 2023, the contents of which are incorporated herein in their entirety.

### BACKGROUND

### 1. Technical Field

The present disclosure relates to tiered deployment of multiple Artificial Intelligence (AI) models, and more specifically to using the different AI models at different times using distinct sets of data to predict outcomes.

### 2. Introduction

Predicting whether a human being will be satisfied with a given experience is a complicated process. While human beings have made such predictions based on body signals, “hunches,” or other non-technical/imprecise measurements, such predictions are inaccurate and lack repeatability.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system at a first time, first data associated with a human undergoing an experience; executing, via at least one processor of the computer system, a first artificial intelligence model, wherein: inputs to the first artificial intelligence model comprise the first data; and outputs of the first artificial intelligence model comprise a first satisfaction prediction for the human regarding the experience; receiving, at the computer system at a second time after the first time, second data associated with the human undergoing the experience, the second data comprising data collected after the first data; and executing, via the at least one processor of the computer system, a second artificial intelligence model, wherein: inputs to the second artificial intelligence model comprise (1) at least a portion of the first data and (2) the second data; and outputs of the second artificial intelligence model comprise a second satisfaction prediction for the human regarding the experience, wherein the second artificial intelligence model has a higher prediction accuracy than the first artificial intelligence model.

A system configured to perform the concepts disclosed herein can include:

at least one processor; and a non-transitory computer-readable storage medium having instructions stored which, when executed by the at least one processor, cause the at least one processor to perform operations comprising: receiving, at a first time, first data associated with a human undergoing an experience; executing a first artificial intelligence model, wherein: inputs to the first artificial intelligence model comprise the first data; and outputs of the first artificial intelligence model comprise a first satisfaction prediction for the human regarding the experience; receiving, at a second time after the first time, second data associated with the human undergoing the experience, the second data comprising data collected after the first data; and executing a second artificial intelligence model, wherein: inputs to the second artificial intelligence model comprise (1) at least a portion of the first data and (2) the second data; and outputs of the second artificial intelligence model comprise a second satisfaction prediction for the human regarding the experience, wherein the second artificial intelligence model has a higher prediction accuracy than the first artificial intelligence model.

A non-transitory computer-readable storage medium configured as disclosed herein can have instructions stored which, when executed by at least one processor, cause the at least one processor to perform operations which include: receiving, at a first time, first data associated with a human undergoing an experience; executing a first artificial intelligence model, wherein: inputs to the first artificial intelligence model comprise the first data; and outputs of the first artificial intelligence model comprise a first satisfaction prediction for the human regarding the experience; receiving, at a second time after the first time, second data associated with the human undergoing the experience, the second data comprising data collected after the first data; and executing a second artificial intelligence model, wherein: inputs to the second artificial intelligence model comprise (1) at least a portion of the first data and (2) the second data; and outputs of the second artificial intelligence model comprise a second satisfaction prediction for the human regarding the experience, wherein the second artificial intelligence model has a higher prediction accuracy than the first artificial intelligence model.

### BRIEF DESCRIPTION OF THE DRAWINGS

FIG. 1 illustrates an example deployment of multiple AI models over time;

FIG. 2 illustrates an example of multiple AI models generating satisfaction predictions;

FIG. 3 illustrates an example of computing power requirements of the multiple AI models;

FIG. 4 illustrates an example of different data available to be used by the multiple AI models;

FIG. 5 illustrates an example method embodiment; and

FIG. 6 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured herein can be used to predict user satisfaction at the end of an experience. While user satisfaction is inherently a subjective determination, human beings often provide data which, through the use of Artificial Intelligence (AI) models, can be used to determine if the user is likely to be satisfied at the conclusion of the experience. Artificial intelligence models as used herein can include, but are not limited to, neural networks, types of machine learning, and evolutionary algorithms, where the AI models are converted to code which can be executed by a computer system. A system configured as disclosed herein can use two or more AI models at distinct times, where each AI model produces a distinct prediction of a human being's likely satisfaction at the end of an experience. Based on the predictions made by the AI models, the system can provide alternative actions which, if implemented, may improve or change the likely final satisfaction of the human.

Consider the following example. An individual (a human being) is in a hospital having undergone a medical procedure. The individual is monitored by various sensors, and doctors, nurses, and other hospital personnel update the individual's chart. As data is collected, that data is input into an AI model, which predicts how if the individual is likely to be happy at the end of the hospital stay (i.e., satisfied), or if the individual is likely to be unhappy at the end of the hospital stay (i.e., dissatisfied). The system can use this satisfaction prediction to generate possible alternative actions which the hospital staff can use to try and improve or mitigate the individual's satisfaction/dissatisfaction. Later, using additional and/or different data, the system can again make a prediction as to the individual's likely satisfaction, and the system can again generate possible ways to improve and/or mitigate that satisfaction level. However, the AI model used at this later time is not the same model used previously. Instead, this subsequent AI model is a different model configured to use additional and/or different data than the first model. In this manner, the subsequent AI model can provide more accurate results at that later time than if the first AI model were used again at that later/subsequent time. This process of using distinct AI models to make updated predictions can continue indefinitely, but requires a minimum of two distinct AI models.

When actions are taken to improve and/or mitigate satisfaction levels, the system can record that information and, upon conclusion of the experience, compare the predicted user satisfaction for the actions taken against the actual user satisfaction. For example, if the system predicted that a patient would be feeling nauseous, so a nurse asked the patient, and then provided nausea medicine based on the patient's response, the system may predict that such actions would improve that patient's satisfaction rating from “okay” to “good.” Hospitals often send out a satisfaction survey after a patient stay and the system, upon receiving the patient's actual satisfaction, can compare the predicted satisfaction against the actual satisfaction. The comparison data can then be used to re-train the AI models, resulting in future iterations of the AI models having more accurate predictions. This retraining process can occur periodically or can occur upon collection of a satisfactory amount of data (e.g., data exceeding a given threshold).

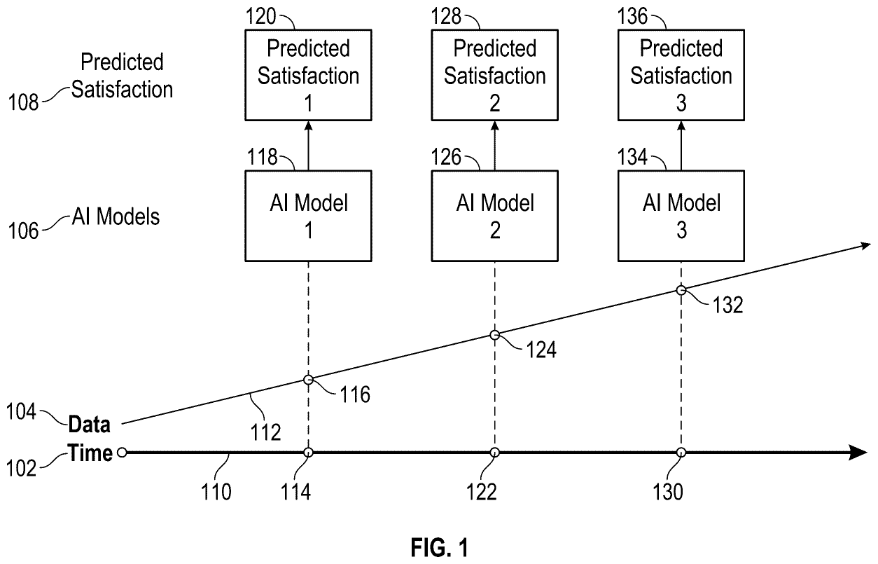

FIG. 1 illustrates an example deployment of multiple AI models over time. In this example, time 102 proceeds in a timeline 110 from left to right. The amount of data 104 being collected increases in a linear manner, illustrated by the data line 112 rising with respect to the timeline 110. In other examples, the amount of data can vary in a step function-like manner, may increase or decrease depending upon data collection and retention at different points of time 102, etc. There are also a number of AI models 106 which provide outputs of predicted satisfaction 108 of the human being engaging in a given experience. In this example, there are three AI models 118, 126, 134, however in other configurations there can be fewer (e.g., two) or more (e.g., four, five, six, etc.). As illustrated, at time 114, there is a certain amount of data 116 which is processed by AI model 1 118, producing predicted satisfaction 1 120. Later, at time 122, there is more data 124 which is processed by AI model 2 126, producing predicted satisfaction 2 128. Finally, at time 130, there is even more data 132 which is processed by AI model 3 134, resulting in predicted satisfaction 3 136.

In this example, each of the AI models 118, 126, 134 is trained in a different manner to provide the same output—a prediction of the user's final satisfaction 120, 128, 136 with a given experience. However, each of the AI models 118, 126, 134 has different input requirements, —different computational requirements, and/or is used at different times.

In other configurations, the amount of data being used by each separate model 118, 126, 134 is the same (e.g., one megabyte of text data describing aspects about an individual), but the type of data being used changes from model to model. For example, in a system predicting patient satisfaction in a hospital an initial model may make predictions of a patient's final satisfaction based on how a surgery went (e.g., based on the surgeon's notes), whereas a later model may make predictions based on how the patient is reacting while in intensive care (e.g., is the patient complaining, how often do they complain, are they taking the prescribed medications, do they have friends/family visiting, etc.). In this manner, the type and source of data used by the subsequent model(s) can vary from an initially deployed model.

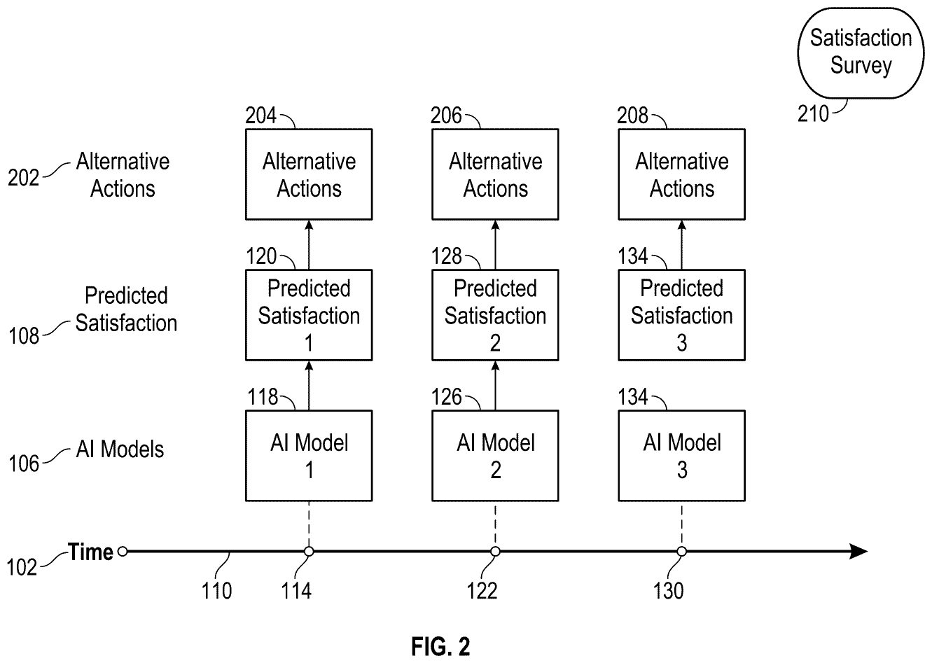

FIG. 2 illustrates an example of multiple AI models generating satisfaction predictions. In this example, the AI models 118, 126, 134 of FIG. 1 and their associated predictions 120, 128, 134 are used by the system to generate alternative actions 202. The alternative actions 202 can be suggestions which, if taken, may result in a different overall level of satisfaction at the end of the experience. Such overall satisfaction can, for example, be determined using a satisfaction survey 210 at the end of the experience.

In this example AI model 1 118 produces predicted satisfaction 1 120 at time 114. The system, using that predicted satisfaction 1 120, may identify that there is a high chance that, if the experience continues along its current path, that the human will ultimately end up with a negative satisfaction of the experience. To remedy this, the system can generate alternative actions 204 based on that predicted satisfaction 1 120. The human, or other humans associated with the experience, can implement those suggestions or continue along the original experience path. Likewise, the illustrated second predicted satisfaction 128 can be used to generate alternative actions 206, and the third predicted satisfaction 134 can be used to generate alternative actions 208. The suggested alternative actions 204, 206, 208 can, depending on the predicted satisfaction used to generate the alternative actions, be the same in each instance. However, in practice the suggested alternative actions 204, 206, 208 will vary in each instance based not only on the associated predicted satisfaction 120, 128, 134, but also the point in time 114, 122, 130 where the AI models 118, 126, 134 are executed.

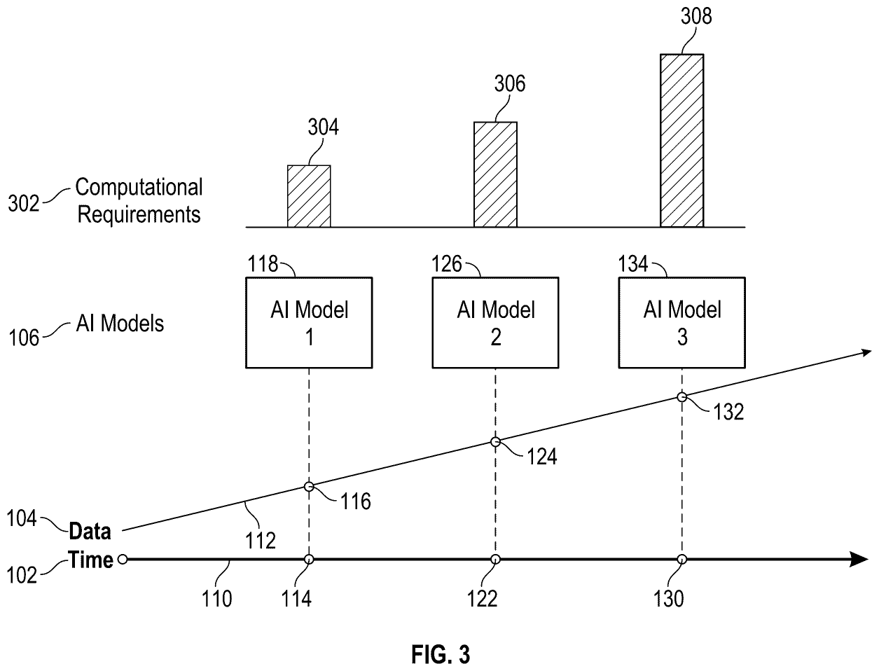

FIG. 3 illustrates an example of computing power requirements of the multiple AI models. In this example, the computational requirements 302 of the respective AI models 118, 126, 134 are shown as increasing over time 110 as the amount of data 112 increases. For example, the computational requirements 302 of AI model 1 118 are less than the computational requirements 306 of AI model 2 126, which are similarly less than the computational requirements 308 of AI model 3 134. In some configurations, the computational requirements of AI models may vary based on the amount of data used by the model, rather than the total amount of data available. In such configurations, the computational requirements 302 of subsequent AI models may decrease or increase, depending on the amount of data used by the respective AI models. Likewise, AI models may be trained for speed and/or accuracy, factors which can also affect the computational requirements. For example, if a first AI model is trained to be less accurate compared to a second AI model, the first/less accurate AI model may have a lower computational requirement than the second/more accurate AI model.

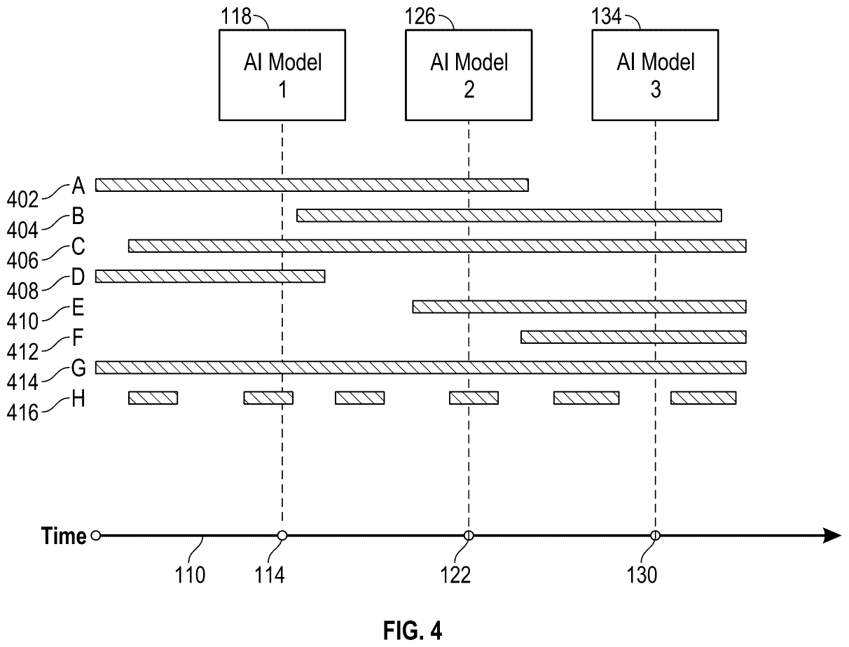

FIG. 4 illustrates an example of different data available to be used by the multiple AI models 118, 126, 134. As illustrated, there are different types of data available to be used by the respective AI models 118, 126, 134. In this example, some of the data types begin at the initialization of the experience, such as A 402, D 408c, and G 414; others, such as B 404, C 406, E 410, and F 412 appear only after a predefined period of time; and others, such as H 416, appear periodically. Depending on specific needs and configurations, the AI models 118, 126, 134. the AI models 118, 126, 134 may use all of the data collected at a given time 110 (e.g., AI model 1 118 uses all of the data collected before time 114), or the AI models 118, 126, 134 may use only a portion of the data collected to that point. In some configurations, the AI models 118, 126, 134 may use only the data being actively collected at that point in time (e.g., AI model 2 126, when executed at time 122, would only use data types A 402, B 404, C 406, E 410, G 414, and H 416, because those are the data types being collected at time 122. The other data types—D 408, F 412—are not being collected and therefore would not, in this example, be used by AI model 2 126).

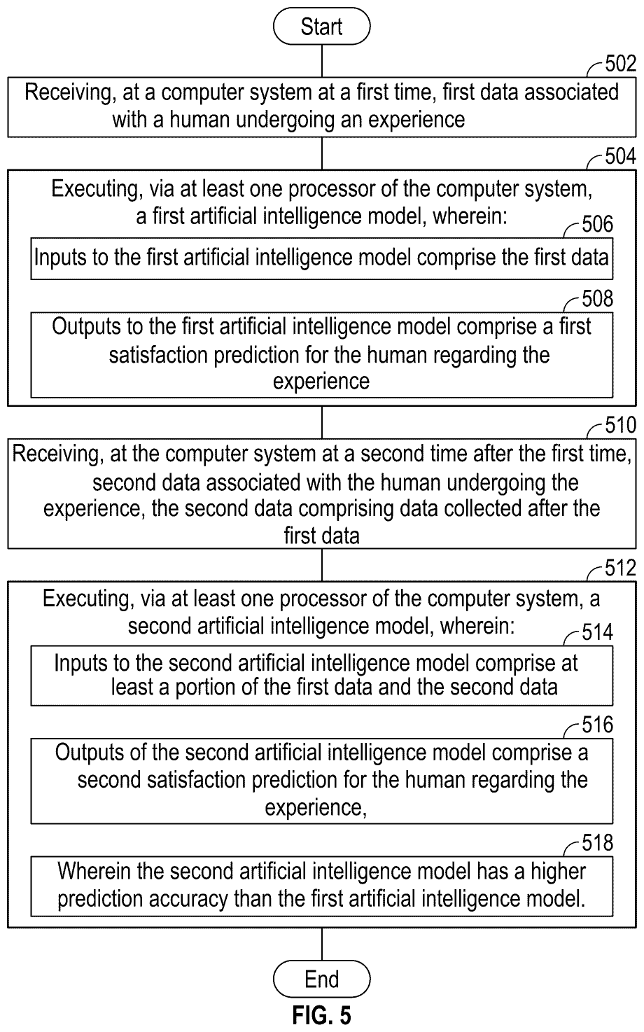

FIG. 5 illustrates an example method embodiment which can, for example, be performed by a computer system (including, for example, desktop computers, laptops, tablets, and cloud-based computers). The method can include receiving, at a computer system at a first time, first data associated with a human undergoing an experience (502), and executing, via at least one processor of the computer system, a first artificial intelligence model (504), wherein: inputs to the first artificial intelligence model comprise the first data (506); and outputs of the first artificial intelligence model comprise a first satisfaction prediction for the human regarding the experience (508). Then, the method can continue by receiving, at the computer system at a second time after the first time, second data associated with the human undergoing the experience, the second data comprising data collected after the first data (510); and executing, via the at least one processor of the computer system, a second artificial intelligence model (512), wherein: inputs to the second artificial intelligence model comprise (1) at least a portion of the first data and (2) the second data (514); and outputs of the second artificial intelligence model comprise a second satisfaction prediction for the human regarding the experience (516), where the second artificial intelligence model has a higher prediction accuracy than the first artificial intelligence model (518).

In some configurations, the second artificial intelligence model can require more computing power than the first artificial intelligence model, whereas in other configurations the second artificial intelligence model can require less computing power than the first artificial intelligence model.

In some configurations, the illustrated method can further include: upon receiving the first satisfaction prediction and before receiving the second data, modifying the experience of the human based upon the first satisfaction prediction. For example, if one or more of the artificial intelligence models predicts that the human is likely to have a negative experience (e.g., a negative satisfaction, adverse outcome, etc.), the system can suggest (to the human or another individual) ways in which the experience can be modified. In other configurations, the system can automatically initiate changes to the experience with the goal of mitigating or eliminating negative outcomes.

For example, if the experience is a medical procedure involving the usage of anesthesia, and the system predicts (using one or more of the AI models) that the human is likely to have a negative experience, a potential adverse outcome of a medical procedure, or a negative reported satisfaction, the system can suggest to a nurse or doctor steps which can be taken to mitigate that negative experience. For example, the system may predict that a given patient is likely to experience nausea and prompt a nurse to ask the patient if they are nauseous (and possibly provide anti-nausea medications based on the patient's response). Likewise, if the system predicts that a patient is likely to be experiencing pain, the system can prompt a doctor or nurse to ask the patient their current pain level. If the system predicts that a given doctor is often identified as disagreeable to patients, the system can automatically suggest that a gift card be provided to the patient upon completion of their stay. Similarly, if patient behavior (e.g., complaining about nurses or doctors) indicates that the patient feels they are not being listened to, the system may suggest that a patient representative visit with the patient.

The same principles can be applied to alternative, non-medical experiences. For example, if the experience is an entertainment experience, such as watching a movie or a video clip on an Internet streaming service, the system, upon predicting that the human is likely having a negative experience, can make a suggestion to the human to adjust the video settings—for example, changing one or more of the volume, closed captioning, a language, translation services, brightness, motion blur, and/or surround sound settings.

In some configurations, the illustrated method may further include: training the first artificial intelligence model using a neural network generation algorithm with a first plurality of training data having fields equal to fields within the first data; and training the second artificial intelligence model using the neural network generation algorithm with a second plurality of training data having fields equal to fields within (1) the at least a portion of the first data and (2) the second data. By training the different models using different sets of training data, the accuracy of the respective AI models can vary.

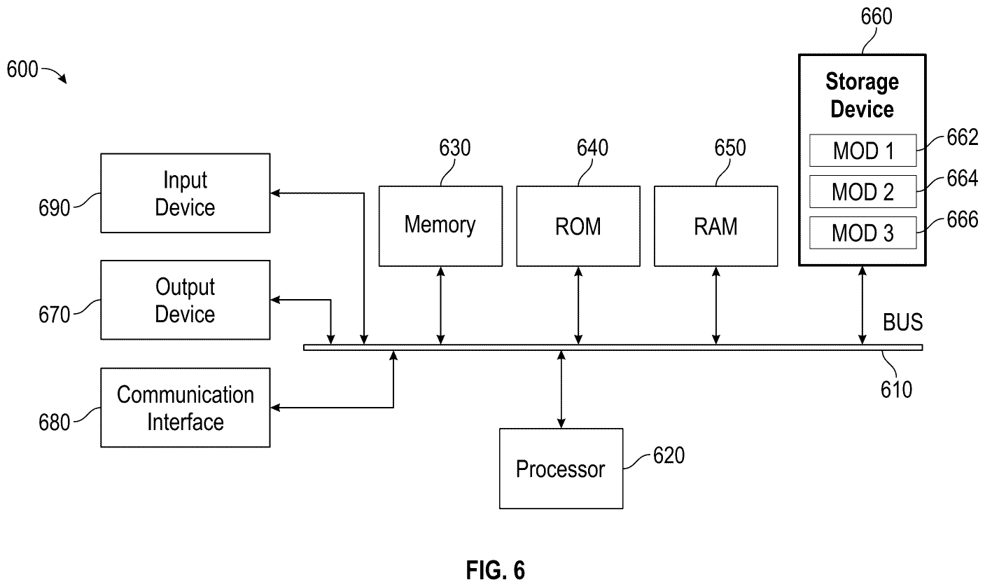

With reference to FIG. 6, an exemplary system includes a computing device 600 (such as a general-purpose computing device), including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in memory ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs the storage device 660 (such as a hard disk), other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system at a first time, first data associated with a human undergoing an experience; executing, via at least one processor of the computer system, a first artificial intelligence model, wherein: inputs to the first artificial intelligence model comprise the first data; and outputs of the first artificial intelligence model comprise a first satisfaction prediction for the human regarding the experience; receiving, at the computer system at a second time after the first time, second data associated with the human undergoing the experience, the second data comprising data collected after the first data; and executing, via the at least one processor of the computer system, a second artificial intelligence model, wherein: inputs to the second artificial intelligence model comprise (1) at least a portion of the first data and (2) the second data; and outputs of the second artificial intelligence model comprise a second satisfaction prediction for the human regarding the experience, wherein the second artificial intelligence model has a higher prediction accuracy than the first artificial intelligence model.

The method of any preceding clause, wherein the second artificial intelligence model requires more computing power than the first artificial intelligence model.

The method of any preceding clause, wherein the second artificial intelligence model requires less computing power than the first artificial intelligence model.

The method of any preceding clause, further comprising: upon receiving the first satisfaction prediction and before receiving the second data, modifying the experience of the human based upon the first satisfaction prediction.

The method of any preceding clause, wherein the experience is a medical procedure.

The method of any preceding clause, wherein the medical procedure comprises usage of anesthesia.

The method of any preceding clause, wherein at least one of the first artificial intelligence model and the second artificial intelligence model identifies a potential adverse outcome of the medical procedure.

The method of any preceding clause, wherein the experience is an entertainment experience.

The method of any preceding clause, wherein the modifying of the entertainment experience comprises at least one of: adjusting volume, providing closed captioning, changing a language, providing a translation, adjusting brightness, adjusting motion blur, and adjusting surround sound.

The method of any preceding clause, further comprising: training the first artificial intelligence model using a neural network generation algorithm with a first plurality of training data having fields equal to fields within the first data; and training the second artificial intelligence model using the neural network generation algorithm with a second plurality of training data having fields equal to fields within (1) the at least a portion of the first data and (2) the second data.

We claim:

1. A method comprising:
receiving, at a computer system at a first time, first data associated with a human undergoing an experience;
executing, via at least one processor of the computer system, a first artificial intelligence model, wherein:
inputs to the first artificial intelligence model comprise the first data; and
outputs of the first artificial intelligence model comprise a first satisfaction prediction for the human regarding the experience;
receiving, at the computer system at a second time after the first time, second data associated with the human undergoing the experience, the second data comprising data collected after the first data; and
executing, via the at least one processor of the computer system, a second artificial intelligence model, wherein:
inputs to the second artificial intelligence model comprise (1) at least a portion of the first data and (2) the second data; and
outputs of the second artificial intelligence model comprise a second satisfaction prediction for the human regarding the experience,
wherein the second artificial intelligence model has a higher prediction accuracy than the first artificial intelligence model.

2. The method of claim 1, wherein the second artificial intelligence model requires more computing power than the first artificial intelligence model.

3. The method of claim 1, wherein the second artificial intelligence model requires less computing power than the first artificial intelligence model.

4. The method of claim 1, further comprising:
upon receiving the first satisfaction prediction and before receiving the second data, modifying the experience of the human based upon the first satisfaction prediction.

5. The method of claim 4, wherein the experience is a medical procedure.

6. The method of claim 5, wherein the medical procedure comprises usage of anesthesia.

7. The method of claim 5, wherein at least one of the first artificial intelligence model and the second artificial intelligence model identifies a potential adverse outcome of the medical procedure.

8. The method of claim 4, wherein the experience is an entertainment experience.

9. The method of claim 8, wherein the modifying of the entertainment experience comprises at least one of: adjusting volume, providing closed captioning, changing a language, providing a translation, adjusting brightness, adjusting motion blur, and adjusting surround sound.

10. The method of claim 1, further comprising:
training the first artificial intelligence model using a neural network generation algorithm with a first plurality of training data having fields equal to fields within the first data; and
training the second artificial intelligence model using the neural network generation algorithm with a second plurality of training data having fields equal to fields within (1) the at least a portion of the first data and (2) the second data.

11. A system comprising:
at least one processor; and
a non-transitory computer-readable storage medium having instructions stored which, when executed by the at least one processor, cause the at least one processor to perform operations comprising:
receiving, at a first time, first data associated with a human undergoing an experience;
executing a first artificial intelligence model, wherein:
inputs to the first artificial intelligence model comprise the first data; and
outputs of the first artificial intelligence model comprise a first satisfaction prediction for the human regarding the experience;
receiving, at a second time after the first time, second data associated with the human undergoing the experience, the second data comprising data collected after the first data; and
executing a second artificial intelligence model, wherein:
inputs to the second artificial intelligence model comprise (1) at least a portion of the first data and (2) the second data; and
outputs of the second artificial intelligence model comprise a second satisfaction prediction for the human regarding the experience,
wherein the second artificial intelligence model has a higher prediction accuracy than the first artificial intelligence model.

12. The system of claim 11, wherein the second artificial intelligence model requires more computing power than the first artificial intelligence model.

13. The system of claim 11, wherein the second artificial intelligence model requires less computing power than the first artificial intelligence model.

14. The system of claim 11, the non-transitory computer-readable storage medium having additional instructions stored which, when executed by the at least one processor, cause the at least one processor to perform operations comprising:
upon receiving the first satisfaction prediction and before receiving the second data, modifying the experience of the human based upon the first satisfaction prediction.

15. The system of claim 14, wherein the experience is a medical procedure.

16. The system of claim 15, wherein the medical procedure comprises usage of anesthesia.

17. The system of claim 15, wherein at least one of the first artificial intelligence model and the second artificial intelligence model identifies a potential adverse outcome of the medical procedure.

18. The system of claim 14, wherein the experience is an entertainment experience.

19. The system of claim 18, wherein the modifying of the entertainment experience comprises at least one of: adjusting volume, providing closed captioning, changing a language, providing a translation, adjusting brightness, adjusting motion blur, and adjusting surround sound.

20. A non-transitory computer-readable storage medium having instructions stored which, when executed by at least one processor, cause the at least one processor to perform operations comprising:
receiving, at a first time, first data associated with a human undergoing an experience;
executing a first artificial intelligence model, wherein:
inputs to the first artificial intelligence model comprise the first data; and
outputs of the first artificial intelligence model comprise a first satisfaction prediction for the human regarding the experience;
receiving, at a second time after the first time, second data associated with the human undergoing the experience, the second data comprising data collected after the first data; and
executing a second artificial intelligence model, wherein:
inputs to the second artificial intelligence model comprise (1) at least a portion of the first data and (2) the second data; and
outputs of the second artificial intelligence model comprise a second satisfaction prediction for the human regarding the experience,
wherein the second artificial intelligence model has a higher prediction accuracy than the first artificial intelligence model.
